(19) United States
(12) Patent Application Publication
(10) Pub. No.: US 2013/0082114 A1
(43) Pub. Date: Apr. 4, 2013

(54) Item Counter

(71) Applicant: Tony Sebastiano, Port Clinton, OH (US)

(72) Inventor: Tony Sebastiano, Port Clinton, OH (US)

(21) Appl. No.: 13/587,236

(22) Filed: Aug. 16, 2012

Related U.S. Application Data
(60) Provisional application No. 61/540,597, filed on Sep. 29, 2011.

(51) Int. Cl. G06M 1/02

(52) U.S. Cl. 235/61 R

(57) ABSTRACT

An item counter provides a means for counting items, such as fish. It includes a chute to guide items toward the counting means. It has an open bottom with a flange so that it may be mounted on top of a separate storage container (such as an ice chest or cooler) to count items as they pass through the item counter and into the storage container.

This application claims priority from U.S. Provisional Application Ser. No. 61/540,597, filed on Sep. 29, 2011, which is hereby incorporated herein by reference.

### BACKGROUND

The present invention relates to counting small items. More particularly, it is envisioned that the present invention may be used to count fish.

Fishing regulations generally set a limit on the number of fish that may be caught in a day. Therefore, it is desirable to have a means for counting fish accurately and easily.

### SUMMARY

The present invention is a device for counting items, such as fish. The item counter includes a chute to receive and guide items toward a flap with an attached counting mechanism, or counter. The counting mechanism responds to the movement of the flap to count items that are dropped into the chute.

The item counter may be used with a separate storage container by placing or securing the item counter to the top of the storage container. Items placed in the chute of the item counter are counted and then stored in the storage container. Examples of possible separate storage containers include ice chests, coolers, live wells (either as a separate container or one built into a boat), buckets, cans, boxes, etc. If desired, the item counter could then be removed from the storage container, and if further desired, it may be placed on another storage container for counting.

As previously mentioned, the item counter includes a chute. The chute is particularly useful for handling fish because fish are typically slippery and may be moving erratically. The chute receives a fish and guides it toward the flap with attached counting mechanism. Without the chute, a fish would be more likely to slip, slide, or flop off of the flap.

### BRIEF DESCRIPTION OF THE DRAWINGS

FIG. 1 is a front perspective view of one embodiment of an item counter made in accordance with the present invention;

FIG. 2 is a side perspective view of the of the item counter of FIG. 1;

FIG. 3 is a cutaway side perspective view of the item counter of FIG. 1;

FIG. 4 is a cutaway rear perspective view of the item counter of FIG. 1; and

FIG. 5 is top perspective view of the item counter of FIG. 1.

### DETAILED DESCRIPTION

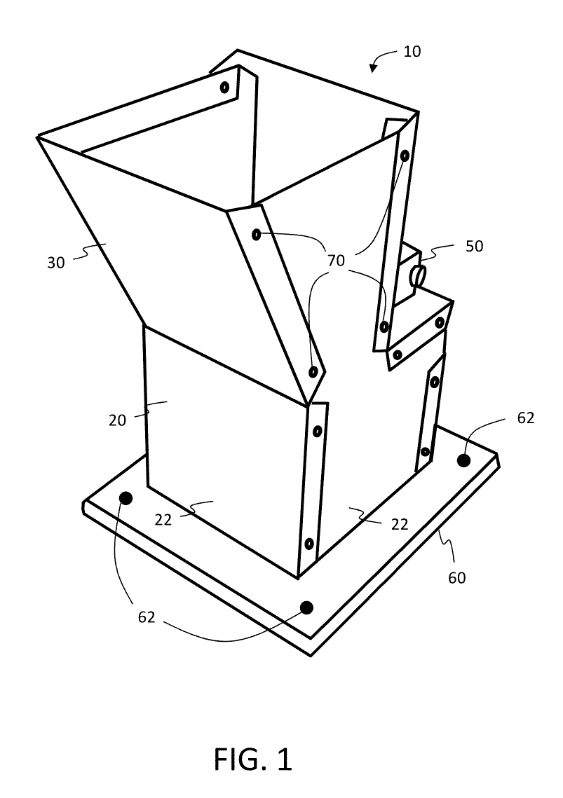

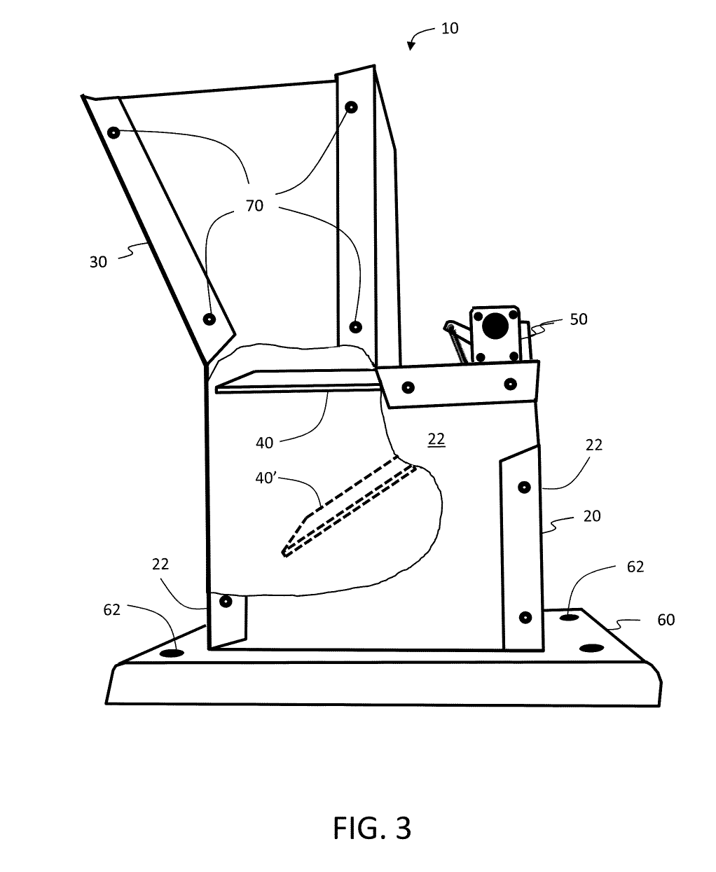

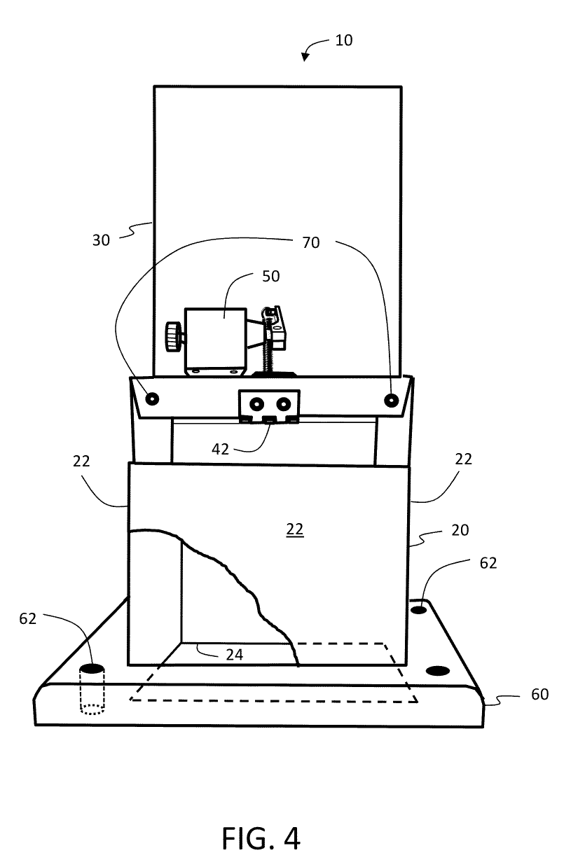

FIGS. 1-5 show one embodiment of an item counter 10. As best shown in FIG. 3, the basic components of the item counter 10 include a base 20, a chute 30 positioned above the base 20, and a flap 40 with an attached counting mechanism 50. The flap 40 is spring-biased to a normally closed position. In the default closed position, the flap 40 lies in a horizontal plane below the chute 30. The flap 40 moves to an open position by pivoting downwardly at hinge 42 (shown best in FIG. 4). A representative open position is denoted by the dashed flap 40′ in FIG. 3.

In use, an item (such as a fish) is placed into the chute 30, the item falls onto the flap 40, forcing the flap 40 to move downwardly. As the flap 40 pivots, an attached counter 50 responds to the movement of the flap 40 by increasing the readout on the counter 50 by one. Once the item passes by the flap 40, the item passes through an opening 24 defined by the base 20, and the flap 40 returns to the closed position.

Typically, the item counter 10 is mounted on a separate storage container (not shown), and the container includes an opening that lines up with the opening 24 defined by the base 20 of the item counter 10. For instance, a hole may be cut in the lid of a standard ice chest/ice cooler, where the hole is substantially the same size as the opening 24 of the item counter 10. The item (e.g. fish) is put in the chute 30, then counted (as it passes the flap 40), then stored in the storage container.

As best shown in FIG. 3, the base 20 in this embodiment has vertical walls 22 that define a hollow space which provides space for the flap to open (and close). The vertical walls 22 are tall enough to allow the flap 40 to pivot downwardly without interference. That is, in this example, the item counter 10 can be placed on a flat surface (such as a tabletop) and the flap 40 would have enough room to pivot to the open position without striking the surface on which it is resting. In addition, the hollow base 20 has an open bottom, which is the opening 24 through which counted items pass. So, the vertical walls 22 of the hollow base 20 separate the flap 40 away from the open bottom in the hollow base 20, and as such, the hollow base 20 houses the flap 40 as it opens and closes, which also helps protect the flap 40 from accidental damage. The vertical walls 22 are also useful when the item counter 10 is placed on top of a typical storage container because the flap 40 does not extend down into the storage container when it opens. As a result, the storage container can be filled up completely, and the flap 40 does not interfere with the contents of the container. For example, a cooler may fill up with fish, and the flap will not strike the fish in the cooler.

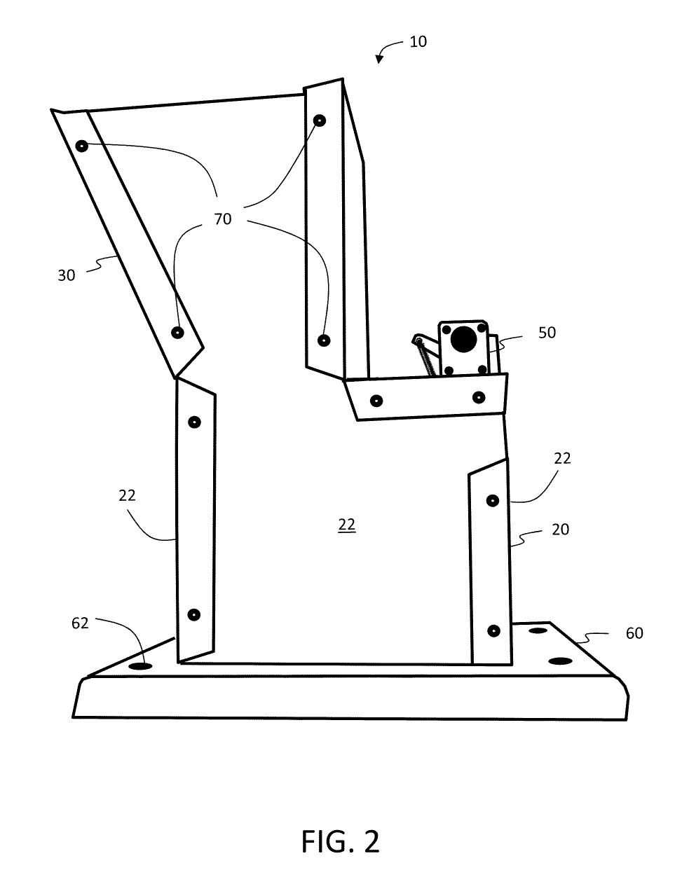

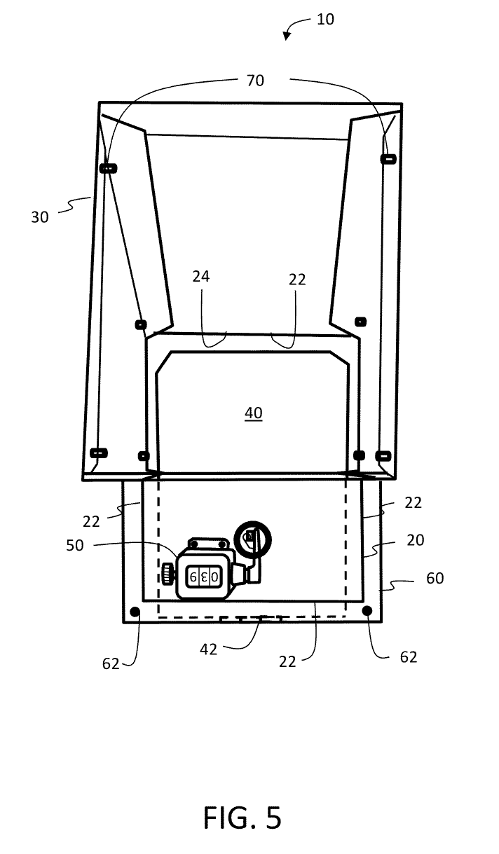

In this particular embodiment and as best shown in FIG. 5, the hollow base 20 has a rectangular cross-sectional shape, and the flap 40 is rectangular. However, the base 20 could take a variety of shapes. For example, the base 20 could also have a circular cross-section (in which case, the base would have a single vertical wall), and the flap could be circular. The base could also be substantially flat, such as a solid, flat plate with appropriate opening (though a hollow base is the preferred embodiment). Further, the chute 30 could also take a variety of shapes. In this embodiment and as best shown in FIG. 2, two of the walls of the chute have a trapezoidal shape, and the cross sectional area at the top of the chute 30 is larger than the cross sectional area near the flap 40. As such, the chute 30 functions as a funnel. In other embodiments, the chute 30 may be an even larger funnel, and it may take a variety of cross sectional shapes, such as circular, square, etc. The chute 30 could also have a similar cross sectional area at the top and bottom, in which case, it would not resemble a funnel. However, the chute 30 would still help guide items toward the flap 40. Finally, the chute 30 and the base 20 could have the same cross sectional shape and size. In such a case, it may be difficult to visually differentiate where the chute ends and the base begins (or vice versa). As such, the base 20 would be the section of the item counter 10 positioned below the counting flap 40 (when the flap is in the default position) and the chute 30 would be the section of the item counter 10 positioned above the counting flap 40 (in the default closed position). Extending outwardly away from the bottom of the hollow base 20 is a flange 60.

The flange 60 allows the item counter 10 to rest easily on a flat surface, such as a table top. The flange 60 also provides a means for securing the item counter 10 to a variety of storage containers. In this particular embodiment, the flange includes mounting holes 62. Screws, bolts, or the like, may be used through the mounting holes 62 to secure the item counter 10 to the lid of a bucket, the cover of a cooler, a sheet of wood, etc. Typically, the lid, cover, etc. would have an opening substantially similar to the size of the opening in the bottom of the item counter. Once secured, an item placed in the item counter would pass through the opening 24 in the bottom of the item counter and then immediately through the opening in the lid, cover, etc. and into the storage container. Although mounting holes are shown in this embodiment, a number of other means may be used to secure the item counter 10 to a storage container, such as adhesives, VELCRO, magnets, etc.

The item counter 10 may be made of any suitable material, such as plastic, aluminum, wood, etc. Generally, it is preferred to be made of a thin, sheet material, such as PVC coated aluminum, so that it is lightweight. In this particular embodiment, sections of the sheet material overlap slightly and are secured together with rivets 70. Of course, other fastening means may be used, such as screws or the like. The flange 60 generally is made of a thicker and heavier material so that it is less likely to tip over and/or to provide a solid mounting means to the separate storage container.

It is envisioned that the item counter be used primarily to count fish as they pass into a storage container, but it may be used to count other items, as well. It will be obvious to those skilled in the art that modifications may be made to the embodiment described above without departing from the scope of the invention.

What is claimed is:

1. An item counter comprising:
a base defining an opening,
a chute extending above said base;
a moveable flap biased to a default position below said chute, and
a counter that responds to the downward movement of said flap.

2. An item counter as recited in claim 1, wherein said base includes one or more vertical walls that define a hollow space and said moveable flap moves downwardly from the default position within said hollow space.

3. An item counter as recited in claim 2, wherein said base includes four vertical walls and has a rectangular cross section.

4. An item counter as recited in claim 2, and further comprising a flange extending outwardly away from the bottom of said one or more vertical walls.

5. An item counter as recited in claim 4, wherein said flange includes means for securing said item counter to a separate storage container.

6. An item counter as recited in claim 1, wherein the cross sectional area toward the top of said chute is larger than the cross sectional area toward the flap.

7. An item counter comprising:
one or more vertical walls defining a hollow base with an open bottom,
a chute extending above said hollow base;
a downwardly pivoting flap housed within said hollow base, and
a counter that responds to the downward pivoting movement of said flap.

8. An item counter as recited in claim 7, wherein said flap is biased to a closed position, and said flap lies in a horizontal plane below said chute in the closed position.

9. An item counter as recited in claim 8, wherein said flap pivots downwardly to an open position, said hollow base has a rectangular cross section. and said vertical walls are taller than said flap in the open position.

10. An item counter as recited in claim 9, and further comprising a flange extending outwardly away from the bottom of the hollow base.

11. An item counter as recited in claim 10, wherein said flange includes means for securing said item counter to a separate storage container.

12. An item counter as recited in claim 8, wherein the cross sectional area toward the top of said chute is larger than the cross sectional area toward the flap.

13. An item counter as recited in claim 7, wherein said chute and said hollow base are formed from PVC coated aluminum sheets.

14. An item counter comprising:
a spring-biased flap with attached counter, wherein said counter counts each downward movement of said flap,
a chute above said flap, said chute configured to guide items placed in said chute toward said flap, and
a hollow base below said chute, said hollow base having an open bottom.

15. An item counter as recited in claim 14, wherein said spring-biased flap moves from a closed position to an open position, and said hollow base includes one or more vertical walls that are taller than said flap in the open position.

16. An item counter as recited in claim 15, wherein said hollow base has a rectangular cross section.

17. An item counter as recited in claim 15, and further comprising a flange extending outwardly away from the bottom of the hollow base.

18. An item counter as recited in claim 17, wherein said flange includes means for securing said item counter to a separate storage container.

19. An item counter as recited in claim 15, wherein the cross sectional area toward the top of said chute is larger than the cross sectional area toward the flap.

20. An item counter as recited in claim 15, wherein said chute and said hollow base are formed from PVC coated aluminum sheets.
